(19) United States
(12) Patent Application Publication
(10) Pub. No.: US 2016/0086552 A1
(43) Pub. Date: Mar. 24, 2016

(54) DISPLAY APPARATUS

(71) Applicant: SAMSUNG DISPLAY CO., LTD., Yongin-City (KR)

(72) Inventors: HYUN-KYU NAMKUNG, Cheonan-si (KR); Jai-Hyun Koh, Hwaseong-si (KR); Sung-Jae Park, Wonju-si (KR); Nam-Jae Lim, Gwacheon-si (KR); Ik-Soo Lee, Seoul (KR)

(21) Appl. No.: 14/721,560

(22) Filed: May 26, 2015

(30) Foreign Application Priority Data
Sep. 23, 2014 (KR) 10-2014-0126907

(51) Int. Cl. G09G 3/36; G09G 3/20

(52) U.S. Cl. CPC G09G 3/3607; G09G 3/2074; G09G 3/3614; G09G 3/3685; G09G 3/3696; G09G 2300/0413; G09G 2300/0452; G09G 2300/0426

(57) ABSTRACT

A display apparatus includes data lines, gate lines, a first pixel unit, a second pixel unit, and a data driver circuit. The data lines extend in a first direction. The gate lines extend in a second direction crossing the first direction. The first pixel unit includes red, green and blue sub pixels. Each of the red, green and blue sub pixels has a short side of the first direction and a long side of the second direction. The second pixel unit includes the red, green and white sub pixels. Each of the red, green and white sub pixels has a short side of the first direction and a long side of the second direction. The data driver circuit outputs a plurality of data voltages to the data lines. Each of the data voltages has a polarity according to an inversion mode.

### CROSS-REFERENCE TO RELATED APPLICATION

This application claims priority under 35 U.S.C. §119 to Korean Patent Application No. 10-2014-0126907, filed on Sep. 23, 2014, in the Korean Intellectual Property Office, the disclosure of which is incorporated by reference herein in its entirety.

### TECHNICAL FIELD

Exemplary embodiments of the present inventive concept relate to a display apparatus, and more particularly to, a display apparatus for improving a display quality.

### DISCUSSION OF THE RELATED ART

A liquid crystal display (LCD) apparatus includes an LCD panel and a driver apparatus configured to drive the LCD panel. The LCD panel includes a plurality of data lines, and a plurality of gate lines crossing the data lines. The data lines and the gate lines may define a plurality of pixels.

The driver apparatus includes a gate driver configured to output a gate signal to a gate line and a data driver configured to a data signal to a data line. The driver apparatus may drive the LCD panel in an inversion mode to prevent the LCD panel from being damaged. In the inversion mode, a polarity of a data voltage applied to a pixel may be reversed.

However, positive and negative polarities of the data voltages may be applied in non-uniform fashion.

### SUMMARY OF THE INVENTION

According to an exemplary embodiment of the present inventive concept, there is provided a display apparatus. The display apparatus includes a plurality of data lines, a plurality of gate lines, a first pixel unit, a second pixel unit, and a data driver. The data lines extend in a first direction. The gate lines extend in a second direction crossing the first direction. The first pixel unit includes red, green and blue sub pixels. Each of the red, green and blue sub pixels has a short side of the first direction and a long side of the second direction. The second pixel unit includes the red, green and white sub pixels. Each of the red, green and white sub pixels has a short side of the first direction and a long side of the second direction. The data driver circuit is configured to output a plurality of data voltages to the data lines. Each of the data voltages has a polarity according to an inversion mode. The first data line of the data lines is connected to red, blue, green and white sub pixels in a first pixel column located on a first side of the first data line. The first data line is connected to green and red sub pixels of a second pixel column located on a second side of the first data line.

In an exemplary embodiment of the present inventive concept, the data voltages applied to the data lines may have polarities reversed every 2N data lines (N is a positive integer equal to or more than two).

In an exemplary embodiment of the present inventive concept, the inversion mode of the data driver circuit may be a 1-dot inversion mode, a square inversion mode, or a quad inversion mode.

In an exemplary embodiment of the present inventive concept, in the 1-dot inversion mode, the data voltages may have a polarity pattern of (+ − + −) along the second direction

In an exemplary embodiment of the present inventive concept, in a square inversion mode, the data voltages may have a polarity pattern of (+ + − −) along the second direction.

In an exemplary embodiment of the present inventive concept, in a quad inversion mode, the data voltages may have a polarity pattern of (+ − + − − + − +) along the second direction.

In an exemplary embodiment of the present inventive concept, the first pixel unit and the second pixel unit may be alternately arranged along one of the first direction or the second direction.

In an exemplary embodiment of the present inventive concept, the data voltages applied to the data lines may have polarities reversed every eight data lines.

In an exemplary embodiment of the present inventive concept, the data voltages applied to the data lines may have polarities reversed every six data lines.

In an exemplary embodiment of the present inventive concept, a second data line of the data lines may be connected to green and red sub pixels of a dummy pixel column located on one side of the second data line

In an exemplary embodiment of the present inventive concept, the green and red sub pixels of the dummy pixel column may be applied with a data voltage corresponding to a predetermined grayscale.

In an exemplary embodiment of the present inventive concept, the predetermined grayscale may be a grayscale corresponding to a black color.

In an exemplary embodiment of the present inventive concept, the sub pixels arranged in the first direction may have different colors from each other, and the sub pixels arranged in the second direction have a same color as each other.

In an exemplary embodiment of the present inventive concept, the blue and white sub pixels may have a size larger than that of the red and green sub pixels.

In an exemplary embodiment of the present inventive concept, the display apparatus may further include a plurality of fan-out lines each connecting one of the plurality of data lines and one of a plurality of output channels of the data driver circuit.

In an exemplary embodiment of the present inventive concept, the fan-out lines may include at least one fan-out line which alternately connects an output channel and a data line that is out of sequence corresponding to the output channel.

According to an exemplary embodiment of the present inventive concept, there is provided a display apparatus. The display apparatus includes a plurality of data lines, a plurality of gate lines, a plurality of pixels, and a data driver circuit. The data lines extend in a first direction. The gate lines extend in a second direction crossing the first direction. The pixels include first through L-th pixel columns and first through M-th pixel rows (L and M are positive integers). The data driver circuit is configured to output a plurality of data voltages to the data lines. Each of the data voltages has a polarity according to an inversion mode. Each of the first through L-th pixel columns includes a first pixel unit and a second pixel unit. The second pixel unit has a different sub pixel from that of the first pixel unit. The first pixel unit and the second pixel unit are alternately arranged in the first and second directions.

In an exemplary embodiment of the present inventive concept, the first pixel unit may include red, green and blue sub pixels, and the second pixel unit may include red, green and white sub pixels.

In an exemplary embodiment of the present inventive concept, a first data line of the data lines may be connected to red, blue, green and white sub pixels in a first pixel column located on a first side of the first data line and may be connected to green and red sub pixels of a second pixel column located on a second side of the first data line. The first side may be different from the second side.

In an exemplary embodiment of the present inventive concept, the data voltages applied to the data lines may have polarities reversed every 2N data lines (N is a positive integer equal to or more than two).

In an exemplary embodiment of the present inventive concept, the inversion mode of the data driver circuit may be a 1-dot inversion mode, a square inversion mode, or a quad inversion mode.

In an exemplary embodiment of the present inventive concept, in the quad mode, the data voltages may have a polarity pattern of (+ − + − + − +) along the second direction.

### DESCRIPTION OF THE DRAWINGS

The above and other features of the present inventive concept will become more apparent by describing in detail exemplary embodiments thereof with reference to the accompanying drawings, in which:

FIG. 1 is a plan view illustrating a display apparatus according to an exemplary embodiment of the present inventive concept;

FIG. 2 is a diagram illustrating a pixel structure of a display panel of FIG. 1 according to an exemplary embodiment of the present inventive concept;

FIG. 3 is a diagram illustrating a driving of the display panel of FIG. 2 according to an exemplary embodiment of the present inventive concept;

FIG. 4 is a plan view illustrating a display apparatus according to an exemplary embodiment of the present inventive concept;

FIG. 5 is a plan view illustrating a display apparatus according to an exemplary embodiment of the present inventive concept; and

FIG. 6 is a plan view illustrating a display apparatus according to an exemplary embodiment of the present inventive concept.

### DETAILED DESCRIPTION OF THE EMBODIMENTS

Hereinafter, exemplary embodiments of the present inventive concept will be described in more detail with reference to the accompanying drawings.

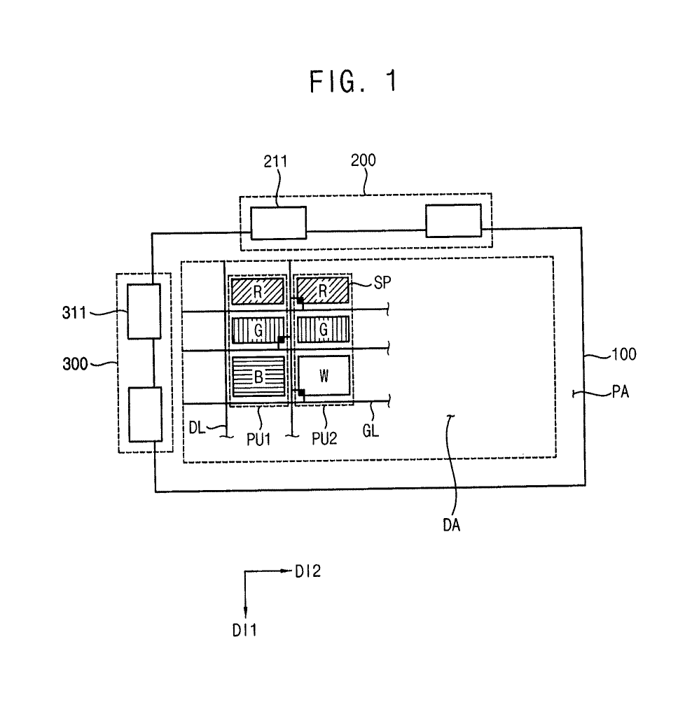

FIG. 1 is a plan view illustrating a display apparatus according to an exemplary embodiment of the present inventive concept.

Referring to FIG. 1, the display apparatus may include a display panel 100, a data driving part 200 and a gate driving part 300.

The display panel 100 may be divided into a display area DA and a peripheral area PA surrounding the display area DA.

The display panel 100 may include a plurality of data lines DL, a plurality of gate lines GL and a plurality of pixel units PU1 and PU2.

The data lines DL extend in a first direction DI1 and are arranged in a second direction DI2 crossing the first direction DI1.

The gate lines GL extend in the second direction DI2 and are arranged in the first direction DI1.

The pixel units PU1 and PU2 are arranged in a matrix type which includes a plurality of pixel columns and a plurality of pixel rows. Each of the pixel columns includes a plurality of pixels arranged in the first direction DI1 and each of the pixel rows includes a plurality of pixels arranged in the second direction DI2.

Each of the pixel units PU1 and PU2 may include a plurality of color sub pixels SP. Each of the color sub pixels SP has a rectangle shape which includes a long side and a short side. The long side is parallel with an extending direction of the gate line GL that is the second direction DI2 and the short side is parallel with an extending direction of the data line DL that is the first direction DI1.

For example, a first pixel unit PU1 may include a red sub pixel R, a green sub pixel G and a blue sub pixel B arranged in the first direction DI1, and a second pixel unit PU2 may include a red sub pixel R, a green sub pixel G and a white sub pixel W arranged in the first direction DI1. A size of the blue and white sub pixels B and W may be larger than that of the red and green sub pixels R and G. The first pixel unit PU1 and the second pixel unit PU2 may be alternately arranged.

The data driving part 200 may be disposed in the peripheral area PA and include a plurality of data driver circuits 211.

Each of the data driver circuits 211 is configured to output a plurality of data voltages to the data lines DL. The data driver circuit 211 is configured to output the data voltages to the data lines DL according to an inversion mode. The data voltages may have a positive polarity (+) and a negative polarity (−) opposite to the positive polarity (+) with respect to a reference voltage.

The gate driving part 300 may be disposed in the peripheral area PA and include a plurality of gate driver circuits 311.

The plurality of gate driver circuits 311 is configured to output a plurality of gate signals to the gate lines GL.

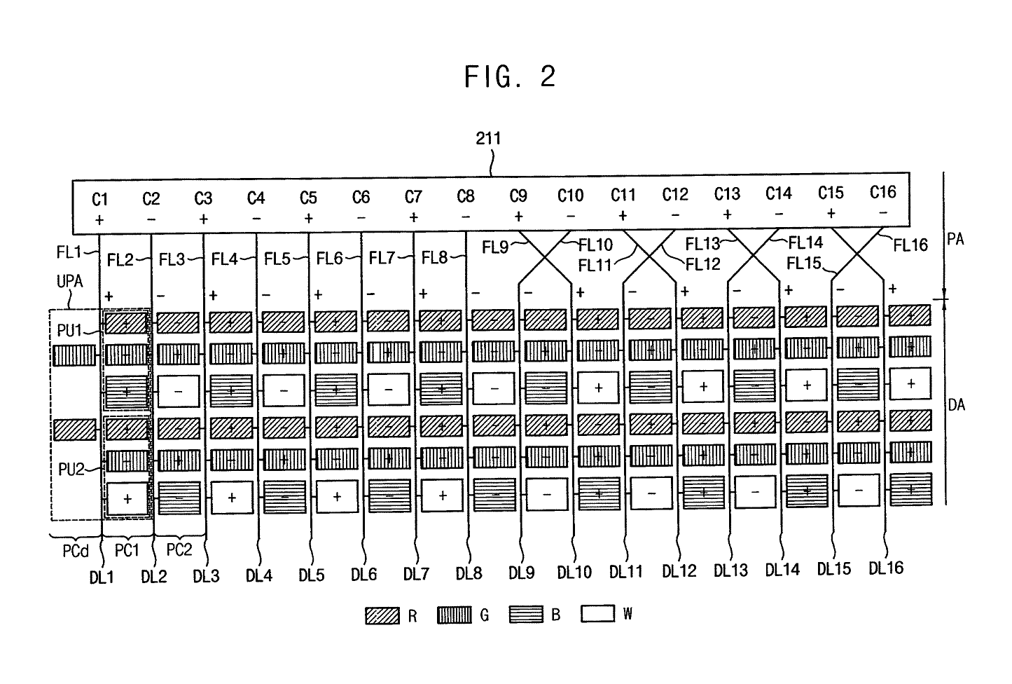

FIG. 2 is a diagram illustrating a pixel structure of a display panel of FIG. 1 according to an exemplary embodiment of the present inventive concept.

Referring to 1 and 2, the display panel 100 may be divided into the display area DA and the peripheral area PA.

The data driver circuit 221 is disposed in the peripheral area PA. The data driver circuit 221 is driven with a 1-dot inversion mode.

A plurality of fan-out lines FL1, . . . , FL16 is disposed in the peripheral area PA.

The fan-out lines FL1, . . . , FL16 respectively connect a plurality of output channels C1, . . . , C16 of the data driver circuit 211 and the data lines DL1, . . . , DL16 in the display area DA.

First to eighth fan-out lines FL1, . . . , FL8 respectively connect first to eighth output channels C1, . . . , C8 and first to eighth data lines DL1, . . . , DL8. For example, a first fan-out line FL1 connects a first output channel C1 and a first data line DL1, and a second fan-out line FL2 connects a second output channel C2 and a second data line DL2.

Ninth to sixteenth fan-out lines FL9, . . . , F16 alternately connect ninth to sixteenth output channels C9, . . . , C16 and ninth to sixteenth data lines DL9, . . . , DL16. Each of the ninth to sixteenth fan-out lines FL9, . . . , F16 alternately connects an output channel and a data line being out of sequence corresponding to the output channel. For example, a k-th fan-out line FLk of the ninth to sixteenth fan-out lines FL9, . . . , F16 (k is a positive integer equal to or greater than 9 and equal to or smaller than 16) connects a k-th output channel Ck and a j-th data line DLj (k≠j), and two adjacent fan-out lines of the ninth to sixteenth fan-out lines FL9, . . . , F16 may alternately connect corresponding output channels and data lines. For example, a ninth fan-out line FL9 connects a ninth output channel C9 and a tenth data line DL10, and a tenth fan-out line FL10 connects a tenth output channel C10 and a ninth data line DL9. Thus, the ninth and tenth fan-out lines FL9 and FL10 alternate each other.

The display area DA includes a plurality of pixel array units UPA having sub pixels. Each of the pixel array unit UPA includes adjacent pixel columns respectively located on both sides of a data line, and the data line is connected to sub pixels of the adjacent pixel columns with a zigzag shape. For example, each of the adjacent pixel columns includes a first pixel unit PU1 and a second pixel unit PU2 which are arranged in the first direction DI1. In the second direction DI2, a first pixel unit PU1 in one of the adjacent pixel columns is adjacent to a second pixel unit PU2 in another one of the adjacent pixel columns. A second pixel unit PU2 in one of the adjacent pixel columns is adjacent to a first pixel unit PU1 in another one of the adjacent pixel columns.

For example, a first data line DL1 is connected to red and blue sub pixels R and B in a first pixel unit PU1 of a first pixel column PC1 located on a right side of the first data line DL1, and to green and white sub pixels G and W in a second pixel unit PU2 of the first pixel column PC1 located on the right side of the first data line DL1.

The first data line DL1 is connected to a green sub pixel G in a first pixel unit PU1 of a dummy pixel column PCd located on a left side of the first data line DL1, and to a red sub pixel R in a second pixel unit PU2 of the dummy pixel column PCd located on the left side of the first data line DL1. A predetermined data voltage, for example, a data voltage corresponding to a black grayscale may be applied to the green and red sub pixels G and R of the dummy pixel column PCd.

Thus, data voltages having a same polarity may be applied to the green and red sub pixels G and R in the dummy pixel column PCd and to the red, blue, green and white sub pixels R, B, G and W in the first pixel column PC1 through the first data line DL1.

As described above, a second data line DL2 is connected to the green and red sub pixels G and R in the first pixel column PC1 located on a left side of the second data line DL2 and the red, blue, green and white sub pixels R, B, G and W in a second pixel column PC2 located on a right side of the second data line DL2.

According to the 1-dot polarity inversion mode, the data driver circuit 221 is configured to alternately output a data voltage having a positive polarity (+) and a data voltage having a negative polarity (−) to the data lines through the output channels C1, . . . , C16.

As shown in FIG. 2, the data driver circuit 211 outputs the data voltages having a first polarity sequence such as (+ − + − + − + −) to the first to eighth fan-out lines FL1, . . . , FL8 through first to eighth output channels C1, . . . , C8. The first to eighth fan-out lines FL1, . . . , FL8 transfer the first to eighth data lines DL1, . . . , DL8 with the data voltages having the first polarity sequence such as (+ − + − + − + −).

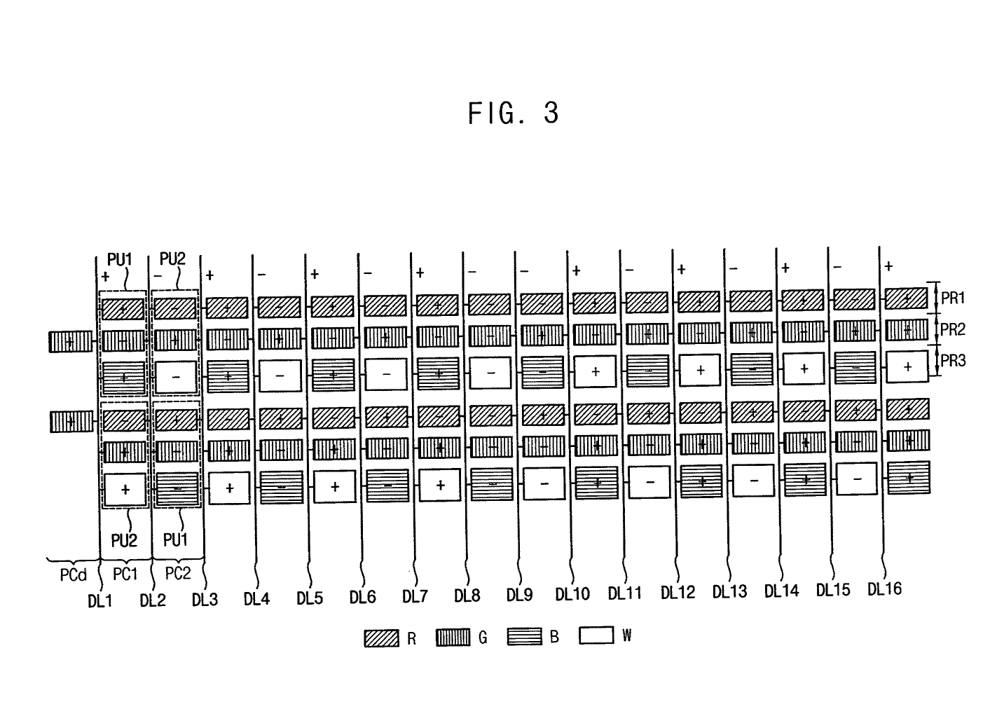

In addition, the data driver circuit 211 outputs the data voltages having the first polarity sequence such as (+ − + − + − + −) to ninth to sixteenth fan-out lines FL9, . . . , FL16 through ninth to sixteenth output channels C9, . . . , C16. Each of the ninth to sixteenth fan-out lines FL9, . . . , FL16 connects an output channel and a data line being out of sequence corresponding to the output channel. For example, a k-th fan-out line FLk of the ninth to sixteenth fan-out lines FL9, . . . , FL16 connects a k-th output channel Ck and a j-th data line DLj. For example, the ninth fan-out line FL9 connects the ninth output channel C9 and the tenth data line DL10, and the tenth fan-out line FL10 connects the tenth output channel C10 and the ninth data line DL9. Thus, as shown in FIG. 3, the data voltages having a second polarity sequence such as (− + − + − + − +) are applied to the ninth to sixteenth data lines DL9, . . . , DL16 through the ninth to sixteenth fan-out lines FL9, . . . , FL16 having an alternate connection structure.

Thus, the second polarity sequence (−+ − + − + − +) of the data voltages applied to the ninth to sixteenth data lines DL9, . . . , DL16 is opposite to the first polarity sequence (+ − + − + − + −) of the data voltages applied to the first to eighth data lines DL1, . . . , DL8.

As described above, a polarity sequence (+ − + − + − + −/− + − + − + − +) of the data voltages applied to all data lines of the display panel is reversed every eight data lines. For example, the data voltages having the first polarity sequence and the data voltages having the second polarity sequence are alternately applied to the data lines every eight data lines.

FIG. 3 is a diagram illustrating a driving of a display panel of FIG. 2 according to an exemplary embodiment of the present inventive concept.

Referring to FIG. 3, the data driver circuit 211 alternately outputs the data voltages of the positive polarity (+) and the negative polarity (−) according to the 1-dot inversion mode and the polarity sequence of the data voltages is reversed every eight data lines.

As shown FIG. 3, in a same pixel row, the data voltages of the positive polarity (+) and the negative polarity (−) may be uniformly distributed.

For example, referring to a first pixel row PR1, the data voltages (+ −) of the positive and negative polarities (+ and −) are alternately and repetitively applied to the red sub pixels R. Referring to a second pixel row PR2, the data voltages (+ −) of the negative and positive polarities (− and +) are alternately and repetitively applied to the green sub pixels G.

Referring to the blue sub pixels B in a third pixel row PR3, the data voltages of the positive polarity (+) are applied to four blue sub pixels B corresponding to the first to eighth data lines DL1, . . . , DL8 and the data voltages of the negative polarity (−) are applied to four blue sub pixels B corresponding to the ninth to sixteenth data lines DL9, . . . , DL16.

Referring to the white sub pixels W in the third pixel row PR3, the data voltages of the negative polarity (−) are applied to four white sub pixels W corresponding to the first to eighth data lines DL1, . . . , DL8 and the data voltages of the positive polarity (+) are applied to four white sub pixels W corresponding to the ninth to sixteenth data lines DL9, . . . , DL16.

As described above, in a same pixel row, the data voltages of the positive and negative polarities (+ and −) may be uniformly distributed. Thus, a ripple of a common voltage which occurs when the data voltages having a single polarity are applied to pixels in the same pixel row may be decreased or eliminated. The common voltage may be a reference voltage for dividing the data voltages into the positive polarity (+) and the negative polarity (−).

In addition, as shown in FIG. 3, the positive and negative polarities of the data voltages applied to same color sub pixels in adjacent pixel columns may be uniformly mixed. For example, the data voltages applied to the same color sub pixels in the adjacent pixel columns have opposite polarities to each other.

For example, the red sub pixel R in the first pixel unit PU1 of the first pixel column PC1 has the data voltage (+) of the positive polarity and the red sub pixel R in the second pixel unit PU2 of the second pixel column PC2 adjacent to the first pixel column PC1 has the data voltage (−) of the negative polarity.

In addition, the red sub pixel R in the second pixel unit PU2 of the first pixel column PC1 has the data voltage (−) of the negative polarity and the red sub pixel R in first pixel unit PU1 of the second pixel column PC2 has the data voltage (+) of the positive polarity.

As shown in FIG. 3, data voltages applied to green, blue or white sub pixels G, B or W in the adjacent pixel columns (e.g., PC1 and PC2) may have opposite polarities to each other. Thus, display defects such as flicker, vertical crosstalk, or the like may be decreased or eliminated. In addition, for example, the polarity sequence of the data voltages may be reversed every eight data lines as driving the display panel with a moving speed of 8 ppf (pixel per frame). When the display panel is driven with 8 ppf, a moving artifact may not be observed. Thus, a display quality of a moving image may be improved.

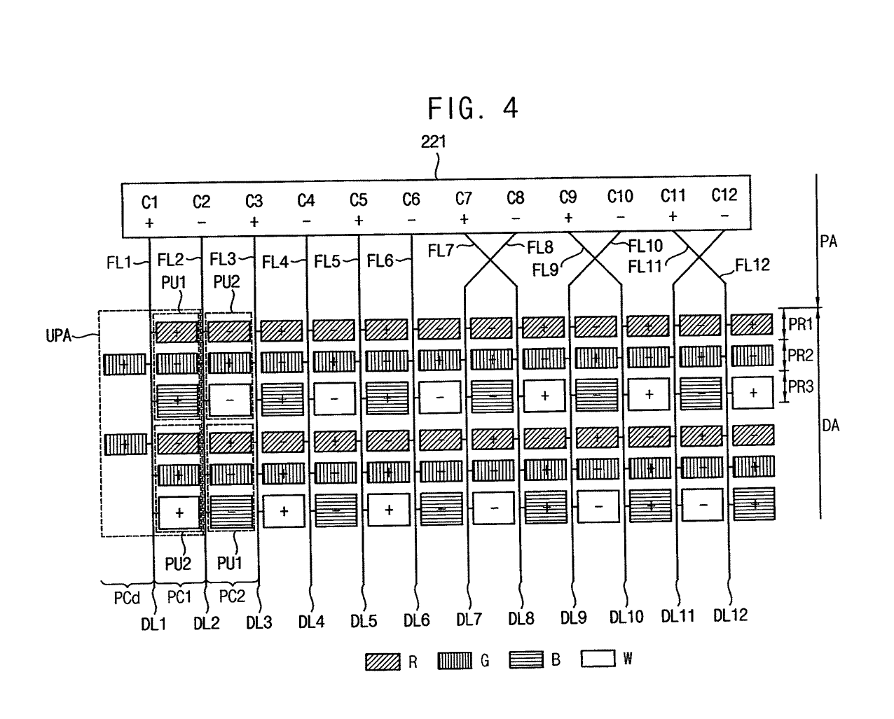

FIG. 4 is a plan view illustrating a display apparatus according to an exemplary embodiment of the present inventive concept.

Hereinafter, the reference numerals used in FIG. 4 may refer to the same elements in FIGS. 1 to 3, and thus, repetitive descriptions may be omitted.

Referring to FIGS. 1 and 4, the display panel 100 may include the display area DA and the peripheral area PA.

The data driver circuit 221 is disposed in the peripheral area PA. The data driver circuit 221 is driven with a 1-dot inversion mode.

A plurality of fan-out lines FL1, . . . , FL12 is disposed in the peripheral area PA.

The fan-out lines FL1, . . . , FL12 respectively connect a plurality of output channels C1, . . . , C12 of the data driver circuit 211 and the data lines DL1, . . . , DL12 in the display area DA.

First to sixth fan-out lines FL1, . . . , FL6 respectively connect first to sixth output channels C1, . . . , C6 and first to sixth data lines DL1, . . . , DL6. For example, a first fan-out line FL1 connects a first output channel C1 and a first data line DL1, and a second fan-out line FL2 connects a second output channel C2 and a second data line DL2.

Seventh to twelfth fan-out lines FL7, . . . , F12 alternately connect seventh to twelfth output channels C7, . . . , C12 and seventh to twelfth data lines DL7, . . . , DL12. For example, a seventh fan-out line FL7 connects a seventh output channel C7 and an eighth data line DL8, and an eighth fan-out line FL8 connects an eighth output channel C8 and a seventh data line DL7. Thus, the seventh and eighth fan-out lines FL7 and FL8 alternate each other.

The display area DA includes a plurality of pixel array units UPA having sub pixels. Each of the pixel array units UPA includes adjacent pixel columns respectively located on both sides of a data line, and the data line is connected to sub pixels of the adjacent pixel columns with a zigzag shape. For example, each of the adjacent pixel columns includes a first pixel unit PU1 and a second pixel unit PU2 which are arranged in the first direction DI1. In the second direction DI2, a first pixel unit PU1 in one of the adjacent pixel columns is adjacent to a second pixel unit PU2 in another one of the adjacent pixel columns. A second pixel unit PU2 in one of the adjacent pixel columns is adjacent to a first pixel unit PU1 in another one of the adjacent pixel columns.

For example, a first data line DL1 is connected to red and blue sub pixels R and B in a first pixel unit PU1 of a first pixel column PC1 located on a right side of the first data line DL1, and to green and white sub pixels G and W in a second pixel unit PU2 of the first pixel column PC1 located on the right side of the first data line DL1.

The first data line DL1 is connected to a green sub pixel G in a first pixel unit PU1 of a dummy pixel column PCd located on a left side of the first data line DL1, and to a red sub pixel R in a second pixel unit PU2 of the dummy pixel column PCd located on the left side of the first data line DL1. A predetermined data voltage, for example, a data voltage corresponding to a black grayscale may be applied to the green and red sub pixels G and R of the dummy pixel column PCd.

Thus, data voltages having a same polarity may be applied to the green and red sub pixels G and R in the dummy pixel column PCd and to the red, blue, green and white sub pixels R, B, G and W in the first pixel column PC1 through the first data line DL1.

As described above, a second data line DL2 is connected to the green and red sub pixels G and R in the first pixel column PC1 located on a left side of the second data line DL2 and the red, blue, green and white sub pixels R, B, G and W in a second pixel column PC2 located on a right side of the second data line DL2.

According to the 1-dot polarity inversion mode, the data driver circuit 221 is configured to alternately output a data voltage having a positive polarity (+) and a data voltage having a negative polarity (−) to the data lines through the plurality of output channels C1, . . . , C12.

As shown in FIG. 4, the data driver circuit 211 outputs the data voltages having a first polarity sequence such as (+ − + − + −) to the first to sixth fan-out lines FL1, . . . , FL6 through first to sixth output channels C1, . . . , C6. The first to sixth fan-out lines FL1, . . . , FL6 transfer the first to sixth data lines DL1, . . . , DL6 with the data voltages having the first polarity sequence such as (+ − + − + −).

In addition, the data driver circuit 211 outputs the data voltages having the first polarity sequence such as (+ − + − + −) to output seventh to twelfth fan-out lines FL7, . . . , FL12 through seventh to twelfth output channels C7, . . . , C12. Each of the seventh to twelfth fan-out lines FL7, . . . , FL12 alternately connects an output channel and a data line being out of sequence corresponding to the output channel. For example, an m-th fan-out line FLm of the seventh to twelfth fan-out lines FL7, . . . , FL12 (m is a positive integer equal to or greater than 7 and equal to or smaller than 12) connects an m-th output channel and an n-th data line DLn (m≠n). For example, the ninth fan-out line FL9 connects the ninth output channel C9 and the tenth data line DL10, and the tenth fan-out line FL10 connects the tenth output channel C10 and the ninth data line DL9. Thus, as shown in FIG. 4, the data voltages having a second polarity sequence such as (− + − + − +) are applied to the seventh to twelfth data lines DL7, . . . , DL12 through the seventh to twelfth fan-out lines FL7, . . . , FL12 having an alternate connection structure.

Thus, the second polarity sequence (− + − + − +) of the data voltages applied to the seventh to twelfth data lines DL7, . . . , DL12 is opposite to the first polarity sequence (+ − + − + −) of the data voltages applied to the first to sixth data lines DL1, . . . , DL6.

As described above, a polarity sequence (+ − + − + −/− + − + − +) of the data voltages applied to all data lines of the display panel is reversed every six data lines. For example, the data voltages having the first polarity sequence and the data voltages having the second polarity sequence are alternately applied to the data lines every six data lines.

As shown in FIG. 4, in a same pixel row, the data voltages having the positive polarity (+) and the data voltages of the negative polarity (−) may be uniformly distributed.

For example, referring to a first pixel row PR1, the data voltages (+ −) of the positive and negative polarities (+ and −) are alternately and repetitively applied to the red sub pixels R. Referring to a second pixel row PR2, the data voltages (+ −) of the negative and positive polarities (− and +) are alternately and repetitively applied to the green sub pixels G.

Referring to the blue sub pixels B in a third pixel row PR3, the data voltages having the positive polarity (+) are applied to three blue sub pixels B corresponding to the first to sixth data lines DL1, . . . , DL6 and the data voltages having the negative polarity (−) are applied to three blue sub pixels B corresponding to the seventh to twelfth data lines DL7, . . . , DL12.

Referring to the white sub pixels W in the third pixel row PR3, the data voltages having the negative polarity (−) are applied to three white sub pixels W corresponding to the first to sixth data lines DL1, . . . , DL6 and the data voltages having the positive polarity (+) are applied to three white sub pixels W corresponding to the seventh to twelfth data lines DL7, . . . , DL12.

As described above, in a same pixel row, the data voltages having the positive and negative polarities (+ and −) may be uniformly distributed. Thus, a ripple of a common voltage which occurs when the data voltages having a single polarity are applied to pixels in the same pixel row may be decreased or eliminated.

In addition, as shown in FIG. 4, the positive and negative polarities of the data voltages applied to same color sub pixels in adjacent pixel columns may be uniformly mixed. For example, the data voltage applied to the same color sub pixels in the adjacent pixel columns have opposite polarities to each other.

For example, the red sub pixel R in the first pixel unit PU1 of the first pixel column PC1 has the data voltage (+) of the positive polarity and the red sub pixel R in the second pixel unit PU2 of the second pixel column PC2 adjacent to the first pixel column PC1 has the data voltage (−) of the negative polarity.

In addition, the red sub pixel R in the second pixel unit PU2 of the first pixel column PC1 has the data voltage (−) of the negative polarity and the red sub pixel R in first pixel unit PU1 of the second pixel column PC2 has the data voltage (+) of the positive polarity.

As shown in FIG. 4, data voltages applied to green, blue or white sub pixels G, B or W in the adjacent pixel columns (e.g., PC1 and PC2) may have opposite polarities to each other. Thus, display defects such as flicker, vertical crosstalk, or the like may be decreased or eliminated.

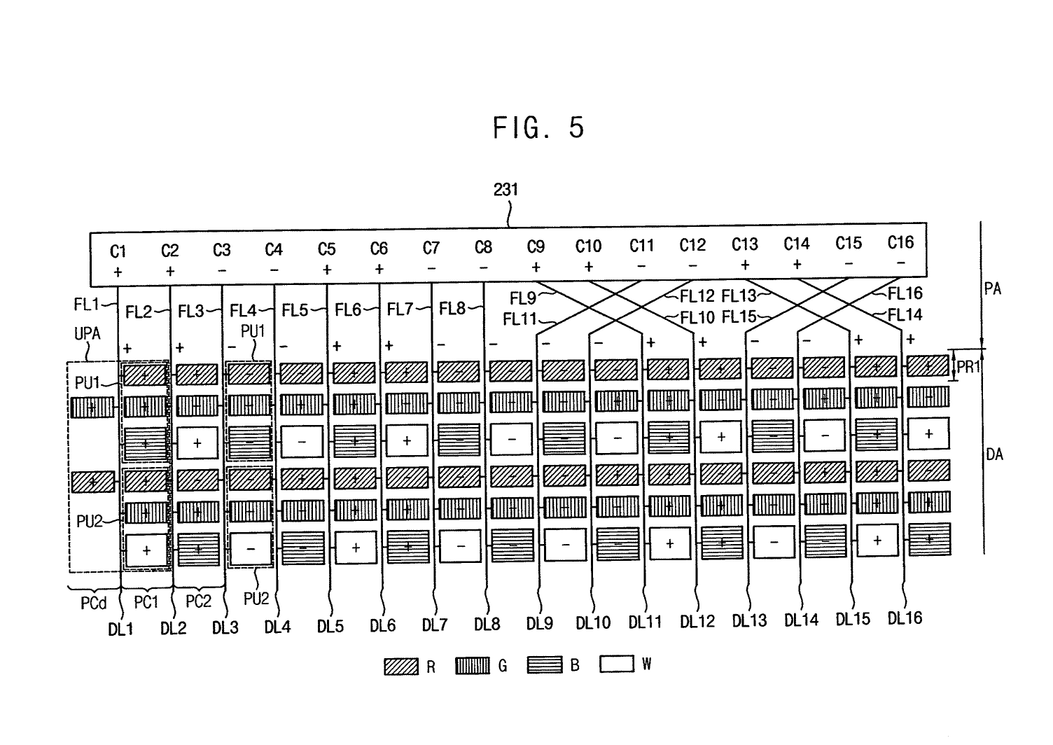

FIG. 5 is a plan view illustrating a display apparatus according to an exemplary embodiment of the present inventive concept.

Hereinafter, the reference numerals used in FIG. 5 may refer to the same elements in FIGS. 1 to 4, and thus, repetitive descriptions may be omitted.

Referring FIGS. 1 and 5, the display panel 100 may include the display area DA and the peripheral area PA.

The data driver circuit 221 is disposed in the peripheral area PA. The data driver circuit 221 is driven with a square inversion mode. In the square inversion mode, the data voltages applied to the data lines have a polarity sequence in which a pattern such as (+ + − −) is repeated.

A plurality of fan-out lines FL1, . . . , FL16 is disposed in the peripheral area PA.

The fan-out lines FL1, . . . , FL16 respectively connect a plurality of output channels C1, . . . , C16 of the data driver circuit 211 and the data lines DL1, . . . , DL16 in the display area DA.

First to eighth fan-out lines FL1, . . . , FL8 respectively connect first to eighth output channels C1, . . . , C8 and first to eighth data lines DL1, . . . , DL8. For example, a first fan-out line FL1 connects a first output channel C1 and a first data line DL1, and a second fan-out line FL2 connects a second output channel C2 and a second data line DL2.

Ninth to sixteenth fan-out lines FL9, . . . , F16 alternately connect ninth to sixteenth output channels C9, . . . , C16 and ninth to sixteenth data lines DL9, . . . , DL16. The ninth to sixteenth fan-out lines FL9, . . . , F16 alternate by a unit of two data lines. For example, a ninth fan-out line FL9 connects a ninth output channel C9 and an eleventh data line DL11, and a tenth fan-out line FL10 connects a tenth output channel C10 and a twelfth data line DL12. An eleventh fan-out line FL11 connects an eleventh output channel C11 and a ninth data line DL9 and a twelfth fan-out line FL12 connects a twelfth tenth output channel C12 and a tenth data line DL10. Thus, the ninth, tenth, eleventh and twelfth fan-out lines FL9, FL10, FL11 and FL12 alternate each other by a unit of two data lines.

The display area DA includes a plurality of pixel array units UPA having sub pixels. Each of the pixel array units UPA includes adjacent pixel columns respectively located on both sides of a data line, and the data line is connected to sub pixels of the adjacent pixel columns with a zigzag shape. Each of the adjacent pixel columns includes a first pixel unit PU1 and a second pixel unit PU2 which are arranged in the first direction DI1.

For example, a first data line DL1 is connected to red and blue sub pixels R and B in a first pixel unit PU1 of a first pixel column PC1 located on a right side of the first data line DL1, and to green and white sub pixels G and W in a second pixel unit PU2 of the first pixel column PC1 located on the right side of the first data line DU.

The first data line DL1 is connected to a green sub pixel G in a first pixel unit PU1 of a dummy pixel column PCd located on a left side of the first data line DL1, and to a red sub pixel R in a second pixel unit PU2 of the dummy pixel column PCd located on the left side of the first data line DL1. A predetermined data voltage, for example, a data voltage corresponding to a black grayscale may be applied to the green and red sub pixels G and R of the dummy pixel column PCd.

Thus, data voltages having a same polarity may be applied to the green and red sub pixels G and R in the dummy pixel column PCd and to the red, blue, green and white sub pixels R, B, G and W in the first pixel column PC1 through the first data line DL1.

As described above, a second data line DL2 is connected to the green and red sub pixels G and R in the first pixel column PC1 located on a left side of the second data line DL2 and to red, blue, green and white sub pixels R, B, G and W in a second pixel column PC2 located on a right side of the second data line DL2.

According to the square inversion mode, the data driver circuit 211 outputs the data voltages having a polarity sequence, in which a pattern such as (+ + − −) is repeated, through the plurality of output channels C1 through C16.

For example, the data driver circuit 211 outputs the data voltages having a polarity sequence such as (+ + − − + + − −) to the first to eighth fan-out lines FL1, . . . , FL8 through first to eighth output channels C1, . . . , C8. The first to eighth fan-out lines FL1, . . . , FL8 transfer the first to eighth data lines DL1, . . . , DL8 with the data voltages having the polarity sequence such as (+ + − − + + − −).

In addition, the data driver circuit 211 outputs the data voltages having a polarity sequence such as (+ + − − + + − −) to ninth to sixteenth fan-out lines FL9, . . . , FL16 through ninth to sixteenth output channels C9, . . . , C16. Each of the ninth to sixteenth fan-out lines FL9, . . . , FL16 connects an output channel and a data line being out of sequence corresponding to the output channel. For example, a k-th fan-out line FLk of the ninth to sixteenth fan-out lines FL9, . . . , FL16 connects a k-th output channel Ck and a j-th data line DLj (k≠j). The ninth to sixteenth fan-out lines FL9, . . . , F16 alternate by a unit of two data lines. Thus, the data voltages having a polarity sequence such as (− − + + − − + +) are applied to the ninth to sixteenth data lines DL9, . . . , DL16 through the ninth to sixteenth fan-out lines FL1, . . . , FL8 having an alternate connection structure.

Thus, the polarity sequence (− − + + − − + +) of the data voltages applied to the ninth to sixteenth data lines DL9, . . . , DL16 is opposite to the polarity sequence (+ + − − + + − −) of the data voltages applied to the first to eighth data lines DL1, . . . , DL8.

As described above, a polarity sequence (+ + − − + + − −/− − + + − − + +) of the data voltages applied to all data lines of the display panel is reversed every eight data lines.

As shown FIG. 5, in a same pixel row, the data voltages having the positive polarity (+) and the data voltages having the negative polarity (−) may be uniformly distributed.

For example, referring to a first pixel row PR1, a number of the red sub pixels R applied with the data voltages of the positive polarity (+) is eight and a number of the red sub pixels R applied with the data voltages of the negative polarity (−) is eight.

Referring to a second pixel row PR2, a number of the green sub pixels G applied with the data voltages of the positive polarity (+) is eight and a number of the green sub pixels G applied with the data voltages of the negative polarity (−) is eight.

Referring to the blue sub pixels B in a third pixel row PR3, a number of the blue sub pixels B applied with the data voltages of the positive polarity (+) is four and a number of the blue sub pixels B applied with the data voltages of the negative polarity (−) is four.

In addition, referring to the white blue sub pixels W in a third pixel row PR3, a number of the white sub pixels W applied with the data voltages of the positive polarity (+) is four and a number of the white sub pixels W applied with the data voltages of the negative polarity (−) is four.

As described above, in a same pixel row, the data voltages of the positive and negative polarities (+ and −) may be uniformly distributed. Thus, a ripple of a common voltage which occurs when the data voltages having a single polarity are applied to pixels in the same pixel row may be decreased or eliminated.

In addition, as shown in FIG. 5, the positive and negative polarities of the data voltages applied to same color sub pixels in adjacent pixel columns may be uniformly mixed.

For example, the red sub pixel R in the first pixel unit PU1 of the first pixel column PC1 has the data voltage (+) of the positive polarity, and a red sub pixel R in a second pixel unit PU2 of a third pixel column PC3 adjacent to the first pixel column PC1 has the data voltage (−) of the negative polarity.

In addition, the red sub pixel R in the second pixel unit PU2 of the first pixel column PC1 has the data voltage (+) of the positive polarity and a red sub pixel R in a first pixel unit PU1 of the third pixel column PC3 has the data voltage (−) of the negative polarity.

As shown in FIG. 5, data voltages applied to green, blue or white sub pixels G, B or W in the adjacent pixel columns (e.g., PC1 and PC3) may be uniformly mixed. Thus, display defects such as flicker, vertical crosstalk, or the like may be decreased or eliminated.

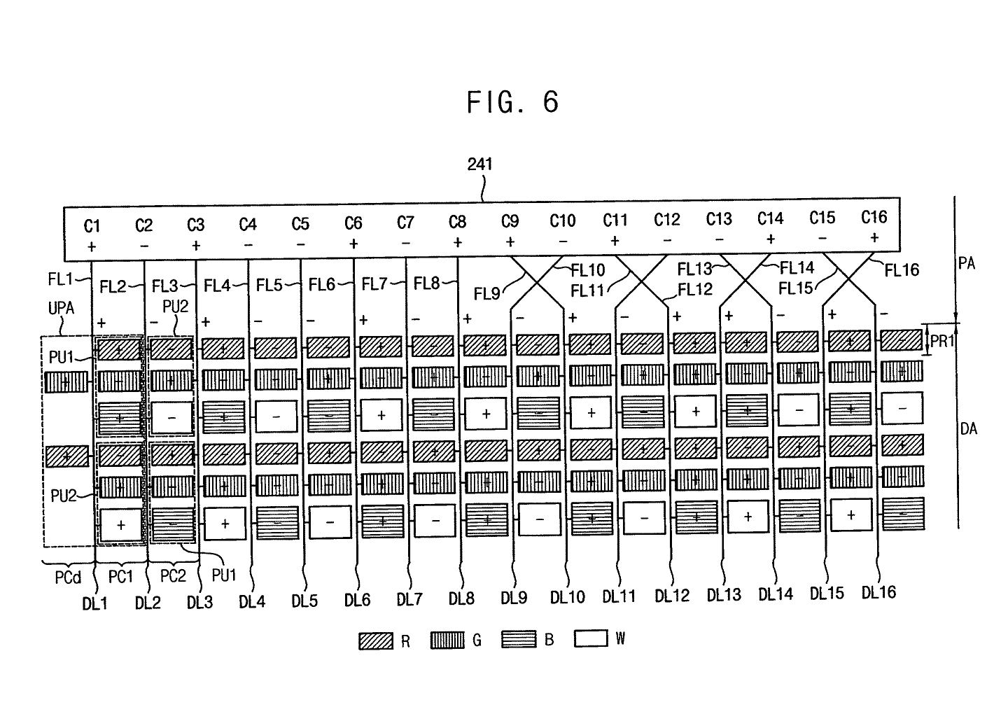

FIG. 6 is a plan view illustrating a display apparatus according to an exemplary embodiment of the present inventive concept.

Hereinafter, the reference numerals used in FIG. 6 may refer to the same elements in FIGS. 1 to 5, and thus, repetitive descriptions may be omitted.

Referring to FIGS. 1 and 6, the display panel 100 may include the display area DA and the peripheral area PA.

The data driver circuit 221 is disposed in the peripheral area PA. The data driver circuit 221 is driven with a quad inversion mode. In the quad inversion mode, the data voltages applied to the data lines have a polarity sequence in which a pattern such as (+ − + − − + − +) is repeated.

A plurality of fan-out lines FL1, . . . , FL16 is disposed in the peripheral area PA.

The fan-out lines FL1, . . . , FL16 respectively connect a plurality of output channels C1, . . . , C16 of the data driver circuit 211 and the data lines DL1, . . . , DL16 in the display area DA.

First to eighth fan-out lines FL1, . . . , FL8 respectively connect first to eighth output channels C1, . . . , C8 and first to eighth data lines DL1, . . . , DL8. For example, a first fan-out line FL1 connects a first output channel C1 and a first data line DL1, and a second fan-out line FL2 connects a second output channel C2 and a second data line DL2.

Ninth to sixteenth fan-out lines FL9, . . . , F16 alternately connect ninth to sixteenth output channels C9, . . . , C16 and ninth to sixteenth data lines DL9, . . . , DL16. For example, a k-th fan-out line FLk of the ninth to sixteenth fan-out lines FL9, . . . , F16 connects a k-th output channel Ck and a j-th data line DLj (k≠j), and two adjacent fan-out lines of the ninth to sixteenth fan-out lines FL9, . . . , F16 may alternately connect corresponding output channels and data lines. For example, a ninth fan-out line FL9 connects a ninth output channel C9 and a tenth data line DL10, and a tenth fan-out line FL10 connects a tenth output channel C10 and a ninth data line DL9. Thus, the ninth and tenth fan-out lines FL9 and FL10 alternate each other.

The display area DA includes a plurality of pixel array units UPA having sub pixels. Each of the pixel array units UPA includes adjacent pixel columns respectively located on both sides of a data line, and the data line is connected to sub pixels of the adjacent pixel columns with a zigzag shape. Each of the adjacent pixel columns includes a first pixel unit PU1 and a second pixel unit PU2 which are arranged in the first direction DI1.

For example, a first data line DL1 is connected to red and blue sub pixels R and B in a first pixel unit PU1 of a first pixel column PC1 located on a right side of the first data line DL1, and to green and white sub pixels G and W in a second pixel unit PU2 of the first pixel column PC1 located on the right side of the first data line DL1.

The first data line DL1 is connected to a green sub pixel G in a first pixel unit PU1 of a dummy pixel column PCd located on a left side of the first data line DL1, and to a red sub pixel R in a second pixel unit PU2 of the dummy pixel column PCd located on the left side of the first data line DL1.

Thus, data voltages having a same polarity may be applied to the green and red sub pixels G and R in the dummy pixel column PCd and to the red, blue, green and white sub pixels R, B, G and W in the first pixel column PC1 through the first data line DL1.

As described above, a second data line DL2 is connected to the green and red sub pixels G and R in the first pixel column PC1 located on a left side of the second data line DL2 and to red, blue, green and white sub pixels R, B, G and W in a second pixel column PC2 located on a right side of the second data line DL2.

According to the quad inversion mode, the data driver circuit 211 outputs the data voltages having a polarity sequence, in which a pattern such as (+ − + − − + − +) is repeated, through the plurality of output channels.

The data driver circuit 211 outputs the data voltages having a polarity sequence such as (+ − + − − + − +) to the first to eighth fan-out lines FL1, . . . , FL8 through first to eighth output channels C1, . . . , C8. The first to eighth fan-out lines FL1, . . . , FL8 transfer the first to eighth data lines DL1, . . . , DL8 with the data voltages having the polarity sequence such as (+ − + − − + − +).

In addition, the data driver circuit 211 outputs the data voltages having a polarity sequence such as (+ − + − − + − +) to ninth to sixteenth fan-out lines FL9, . . . , FL16 through ninth to sixteenth output channels C9, . . . , C16. Thus, the data voltages having a polarity sequence such as (− + − + + − + −) are applied to the ninth to sixteenth data lines DL9, . . . , DL16 through the ninth to sixteenth fan-out lines FL1, . . . , FL8 having an alternate connection structure.

Thus, the polarity sequence (− + − + + − + −) of the data voltages applied to the ninth to sixteenth data lines DL9, . . . , DL16 is opposite to the polarity sequence (+ − + − − + − +) of the data voltages applied to the first to eighth data lines DL1, . . . , DL8.

As described above, a polarity sequence (+ − + − − + − +/− + − + + − + −) of the data voltages applied to all data lines of the display panel is reversed every eight data lines.

As shown FIG. 6, in a same pixel row, the data voltages having the positive polarity (+) and the data voltages having the negative polarity (−) may be uniformly distributed.

For example, referring to a first pixel row PR1, a number of the red sub pixels R applied with the data voltages of the positive polarity (+) is eight and a number of the red sub pixels R applied with the data voltages of the negative polarity (−) is eight.

Referring to a second pixel row PR2, a number of the green sub pixels G applied with the data voltages of the positive polarity (+) is eight and a number of the green sub pixels G applied with the data voltages of the negative polarity (−) is eight.

Referring to the blue sub pixels B in a third pixel row PR3, a number of the blue sub pixels B applied with the data voltages of the positive polarity (+) is four and a number of the blue sub pixels B applied with the data voltages of the negative polarity (−) is four.

In addition, referring to the white blue sub pixels W in a third pixel row PR3, a number of the white sub pixels W applied with the data voltages of the positive polarity (+) is four and a number of the white sub pixels W applied with the data voltages of the negative polarity (−) is four.

As described above, in a same pixel row, the data voltages of the positive and negative polarities (+ and −) may be uniformly distributed. Thus, a ripple of a common voltage which occurs when the data voltages having a single polarity are applied to pixels in the same pixel row may be decreased or eliminated.

In addition, as shown in FIG. 6, the positive and negative polarities of the data voltages applied to same color sub pixels in adjacent pixel columns may be uniformly mixed.

For example, the red sub pixel R in the first pixel unit PU1 of the first pixel column PC1 has the data voltage (+) of the positive polarity, and the red sub pixel R in the second pixel unit PU2 of the second pixel column PC2 adjacent to the first pixel column PC1 has the data voltage (−) of the negative polarity.

In addition, the red sub pixel R in the second pixel unit PU2 of the first pixel column PC1 has the data voltage (−) of the negative polarity, and the red sub pixel R in first pixel unit PU1 of the second pixel column PC2 has the data voltage (+) of the positive polarity.

As shown in FIG. 6, data voltages applied to green, blue or white sub pixels G, B or W in the adjacent pixel columns (e.g., PC1 and PC2) may have opposite polarities to each other. Thus, display defects such as flicker, vertical crosstalk, or the like may be decreased or eliminated. In addition, the polarity sequence of the data voltages is reversed every eight data lines as driving the display panel with a moving speed of 8 ppf (pixel per frame). When the display panel is driven with 8 ppf, a moving artifact may not be observed. Thus, a display quality of a moving image may be improved.

As described above, according to an exemplary embodiment of the present inventive concept, the data voltages applied to the data lines have polarities being reversed every N data lines (N is an even positive integer, equal to or greater than four, and thus, the positive and negative polarities of the data voltages in a same pixel row may be uniformly distributed and the positive and negative polarities of the data voltages applied to same color sub pixels in adjacent pixel columns may be uniformly mixed. Therefore, a ripple of a common voltage which occurs when the data voltages having a single polarity are applied to pixels in the same pixel row may be decreased or eliminated and display defects such as flicker, vertical crosstalk, or the like may be decreased or eliminated.

The foregoing is illustrative of exemplary embodiments of the present inventive concept, the present inventive concept should not be construed as being limited to the exemplary embodiments disclosed herein. Although a few exemplary embodiments of the present inventive concept have been described, it will be understood that many modifications in forms and details may be made thereto without departing from the spirit and scope of the present inventive concept as defined in the appended claims.

What is claimed is:

1. A display apparatus comprising:
a plurality of data lines extending in a first direction;
a plurality of gate lines extending in a second direction crossing the first direction;
a first pixel unit comprising red, green and blue sub pixels, each of the red, green and blue sub pixels having a short side along the first direction and a long side along the second direction;
a second pixel unit comprising red, green and white sub pixels, each of the red, green and white sub pixels having a short side along the first direction and a long side along the second direction; and
a data driver circuit configured to output a plurality of data voltages to the data lines, each of the data voltages having a polarity according to an inversion mode,
wherein a first data line of the data lines is connected to red, blue, green and white sub pixels in a first pixel column located on a first side of the first data line and is connected to green and red sub pixels of a second pixel column located on a second side of the first data line.

2. The display apparatus of claim 1, wherein the data voltages applied to the data lines have polarities reversed every 2N data lines (N is a positive integer equal to or more than two).

3. The display apparatus of claim 1, wherein the inversion mode of the data driver circuit is a 1-dot inversion mode, a square inversion mode, or a quad inversion mode.

4. The display apparatus of claim 3, wherein in the 1-dot inversion mode, the data voltages have a polarity pattern of (+ − + −) along the second direction.

5. The display apparatus of claim 3, wherein in the square inversion mode, the data voltages have a polarity pattern of (+ + − −) along the second direction.

6. The display apparatus of claim 3, wherein in the quad mode, the data voltages have a polarity pattern of (+ − + − − + − +) along the second direction.

7. The display apparatus of claim 1, wherein the first pixel unit and the second pixel unit are alternately arranged along one of the first direction or the second direction.

8. The display apparatus of claim 1, wherein the data voltages applied to the data lines have polarities reversed every eight data lines.

9. The display apparatus of claim 1, wherein the data voltages applied to the data lines have polarities reversed every six data lines.

10. The display apparatus of claim 1, wherein a second data line of the data lines is connected to green and red sub pixels of a dummy pixel column located on one side of the second data line

11. The display apparatus of claim 10, wherein the green and red sub pixels of the dummy pixel column are applied with a data voltage corresponding to a predetermined grayscale.

12. The display apparatus of claim 11, wherein the predetermined grayscale is a grayscale corresponding to a black color.

13. The display apparatus of claim 1, wherein the sub pixels arranged in the first direction have different colors from each other, and the sub pixels arranged in the second direction have a same color as each other.

14. The display apparatus of claim 1, wherein the blue and white sub pixels have a size larger than that of the red and green sub pixels.

15. The display apparatus of claim 1, further comprising a plurality of fan-out lines each connecting one of the plurality of data lines and one of a plurality of output channels of the data driver circuit.

16. The display apparatus of claim 15, wherein the fan-out lines comprise at least one fan-out line which alternately connects an output channel and a data line that is out of sequence corresponding to the output channel.

17. A display apparatus comprising:
a plurality of data lines extending in a first direction;
a plurality of gate lines extending in a second direction crossing the first direction;
a plurality of pixels including first through L-th pixel columns and first through M-th pixel rows (L and M are positive integers); and
a data driver circuit configured to output a plurality of data voltages to the data lines, each of the data voltages having a polarity according to an inversion mode,
wherein each of the first through L-th pixel columns includes a first pixel unit and a second pixel unit, and the second pixel unit has a different sub pixel from that of the first pixel unit, and
wherein the first pixel unit and the second pixel unit are alternately arranged in the first and second directions.

18. The display apparatus of claim 17, wherein the first pixel unit includes red, green and blue sub pixels, and the second pixel unit includes red, green and white sub pixels,
a first data line of the data lines is connected to red, blue, green and white sub pixels in a first pixel column located on a first side of the first data line and is connected to green and red sub pixels of a second pixel column located on a second side of the first data line, and
wherein the first side is different from the second side.

19. The display apparatus of claim 17, wherein the data voltages applied to the data lines have polarities reversed every 2N data lines (N is a positive integer equal to or more than two).

20. The display apparatus of claim 17, wherein the inversion mode of the data driver circuit is a 1-dot inversion mode, a square inversion mode, or a quad inversion mode, and
wherein in the quad mode, the data voltages have a polarity pattern of (+ − + − − + − +) along the second direction.
